(19) United States
(12) Patent Application Publication
(10) Pub. No.: US 2006/0182020 A1
(43) Pub. Date: Aug. 17, 2006

(54) Point-in-time data replication method apparatus and system

(76) Inventors: Michael E. Factor, Haifa (IL); Gail Andrea Spear, Tucson, AZ (US); Warren Keith Stanley, Loveland, CO (US); John Glenn Thompson, Tucson, AZ (US)

Correspondence Address: KUNZLER & ASSOCIATES, 8 EAST BROADWAY, SUITE 600, SALT LAKE CITY, UT, 84111, US

(21) Appl. No.: 11/047,049

(22) Filed: Jan. 31, 2005

(51) Int. Cl. H04J 3/14; H04L 12/26

(52) U.S. Cl. 370/220

(57) ABSTRACT

An apparatus, system, and method are disclosed for replicating point-in-time copies of local data to a remote site. The present invention mirrors point-in-time copy directives on the local data store to initiate a point-in-time copy operation on the remote copy of the local data, thereby efficiently providing remote access to a point-in-time copy of a dataset. Data integrity is ensured by committing local and remote point-in-time copy operations subsequent to successful initiation of both local and remote point-in-time copy operations. The present invention also, in one embodiment, rolls back a point-in-time copy operation in response to a failure to replicate the copy operation.

### BACKGROUND OF THE INVENTION

1. Field of the Invention

This invention relates to methods, apparatus, and systems for replicating data, and more particularly relates to methods, apparatus, and systems for remote replication of point-in-time copies of local data.

2. Description of the Related Art

Data processing systems often work with large amounts of data and require means and methods to manage the storage and archiving of that data. For example, transaction processing systems typically access large databases and log results such as transaction records at a very high rate. The ability to quickly and reliably copy data from one storage area to another enables the deployment of efficient and reliable high-performance processing applications and systems.

Fast replication techniques such as point-in-time copy, one example of which is IBM's flashcopy™ technology have been developed in response to the need for efficient copying mechanisms within high-performance processing systems. A point-in-time copy operation replicates data in a manner that appears instantaneous and allows a host to continue accessing a volume while actual data transfers are deferred to a later time.

Point-in-time copy techniques typically defer the transfer of a data block to the secondary volume until a write operation is requested to that particular block on the primary volume. Data transfers may also proceed as a background process with minimal impact on overall system performance. Until the actual data transfer occurs, read operations to the secondary volume are redirected to the primary volume. Point-in-time copy techniques greatly increase the performance of data processing systems and are preferably conducted by the storage subsystem in a manner that is transparent to the host or file system and that enable the host or file system to continue processing rather than suspending operation while the data transfers occur.

Another data replication technique, known as remote mirroring, replicates local data to remote sites. One well known example of remote mirroring is the peer-to-peer remote copy (PPRC) protocol. Benefits provided by remote mirroring systems such as PPRC include fast remote access, fault tolerance, and disaster recovery. Fast remote access occurs because the mirroring system makes data available at a remote site before it is requested, eliminating the need to retrieve data over relatively slow communication lines.

Remotely mirrored systems also contribute to fault tolerance because data is made available at a remote site even when communication between the local and remote site is interrupted. Mirroring systems facilitate disaster recovery in that the data copied to a remote site serves as a backup copy of the data at the local site. Moreover, since the mirrored remote copy of the data is stored on a system designed to provide real-time access to the data, recovery may proceed more quickly after a disaster than if the data is recovered from typical backup media like tape or optical disk.

The advantages associated with the use of fast replication techniques at a local site may also result when fast replication is used at a remote site. A complication arises, however, when both mirroring and fast replication are used at local and remote sites. If a volume and its point-in-time copy are both mirrored at the remote site, the mirroring process between the local and remote point-in-time copies typically proceeds more slowly than fast replication techniques, and may result in the two point-in-time copies of the data becoming unsynchronized.

In systems that conduct both fast replication and remote data mirroring, maintaining the integrity of synchronized datasets also involves proper handling of data copy errors. If a point-in-time copy operation or a mirroring operation fails, the data on the local and remote volumes may be unsynchronized and require specific recovery operations to resynchronize the volumes. Often such recovery operations require specialized knowledge of the mirroring and fast replication relationships and may require the services of a technician or specialized recovery sequences programmed into the calling application.

From the foregoing discussion, it should be apparent that a need exists for an apparatus, system, and method that automatically mirrors point-in-time copy directives between a local and remote site and gracefully recovers from any errors or faults that may occur. Beneficially, such an apparatus, system, and method would provide local and remote access to a data volume and its point-in-time copies in a transparent manner.

### SUMMARY OF THE INVENTION

The present invention has been developed in response to the present state of the art, and in particular, in response to the problems and needs in the art that have not yet been fully solved by currently available data replication systems. Accordingly, the present invention has been developed to provide an apparatus, system, and method for local and remote replication of data that overcome many or all of the above-discussed shortcomings in the art.

In one aspect of the present invention, the apparatus for local and remote replication of data is provided with a logic unit containing a plurality of modules configured to functionally execute the necessary steps of replicating point-in-time copies of local data to a remote location. These modules in the described embodiments include a local copy module, a remote copy module, a local mirroring module, and a remote mirroring module.

The apparatus, in one embodiment, is configured to mirror point-in-time copy directives received on the local data store and thereby initiate a point-in-time copy operation on the remote (mirrored) copy of the local data. The apparatus is further configured, in one embodiment, to commit local and remote point-in-time copy operations in response to successfully initiating both local and remote point-in-time copy operations. In a further embodiment, the apparatus may be configured to roll back a successfully initiated point-in-time copy operation in response to a point-in-time copy failure.

A system of the present invention is also presented to provide local and remote point-in-time copies of local data. The system may include a local data store and a remote data store. The local data store may be configured to mirror local data to a remote data store and mirror point-in-time copy directives to the remote data store. The local and remote data stores may also be configured to revert a point-in-time copy operation in response to a failed point-in-time copy operation on the other data store.

A method of the present invention is also presented for local and remote replication of point-in-time copies of local data. The method in the disclosed embodiments substantially includes the steps necessary to carry out the functions presented above with respect to the operation of the described apparatus and system. In one embodiment, the method includes mirroring local data to a remote data store, receiving a point-in-time copy directive, and mirroring the point-in-time copy directive to the remote data store. The method also may include rolling back a successfully initiated point-in-time copy operation in response to an error.

In a further embodiment, the method includes options for responding to point-in-time data copy failures. Responding to a point-in-time data copy failure may include proceeding via alternate communication channels in the event of a failure to replicate a point-in-time copy directive. Additionally, handling a point-in-time data copy failure may include returning a failure status to the calling process and deferring error handling to the particular application or system utility that invoked the point-in-time copy directive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention reduces the complexity of data replication in mirrored data storage systems. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a copy replication system in accordance with the present invention;

FIG. 2 is a schematic flow chart diagram illustrating one embodiment of a data replication method in accordance with the present invention;

FIG. 3 is a schematic flow chart diagram illustrating one embodiment of an initiation error handling method in accordance with the present invention; and

FIG. 4 is a schematic flow chart diagram illustrating one embodiment of a data commit error handling method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single dataset, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

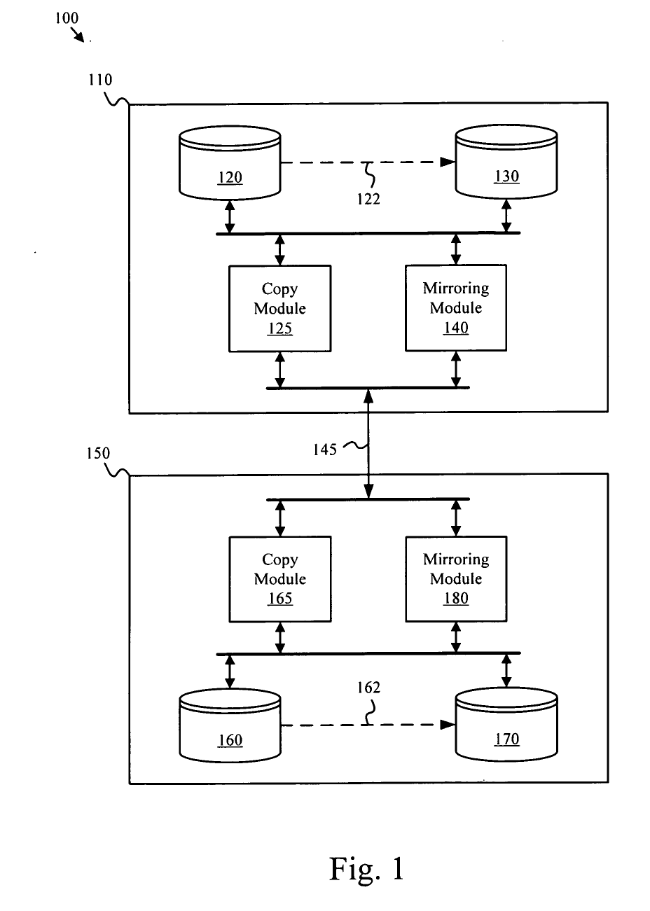

FIG. 1 is a schematic block diagram illustrating one embodiment of a copy replication system 100 in accordance with the present invention. The copy replication system 100 includes a local storage system 110 and a remote storage system 150. The copy replication system 100 facilitates high-speed access to data at both local and remote sites, and provides the attendant benefits of recovery from temporary communication disruptions between the two sites, and the potential for data recovery if data were to become lost at either site due to disaster or other unforeseen events.

The depicted local storage system 110 includes a local source volume 120, a local volume relationship 122, a local copy module 125, a local copy volume 130, and a local mirroring module 140. The depicted remote storage system 150 includes a remote source volume 160, a remote volume relationship 162, a remote copy module 165, a remote copy volume 170, and a remote mirroring module 180. Communication between the local and remote portions of the copy replication system 100 is effected by a communication link 145.

The copy replication system 100 manages the process of copying point-in-time copy directives from the local storage system 110 to the remote storage system 150. In some embodiments, the local storage system 110 and the remote storage system 150 are substantially identical in architecture, with the capability included in the local and remote mirroring modules 140 and 180 to determine whether they are part of the local storage system 110 or the remote storage system 150. In one embodiment, the systems 110 and 150 may have a symmetrical relationship and provide remote storage for each other.

By copying or directing point-in-time copy directives to the remote storage system 150, the local storage system 110 establishes relationships between the various volumes of the copy replication system 100. These relationships may be established by negotiation between the local mirroring module 140 and the remote mirroring module 180 via the communication link 145. In some embodiments, volume relationships may be established by other components of the copy replication system 100.

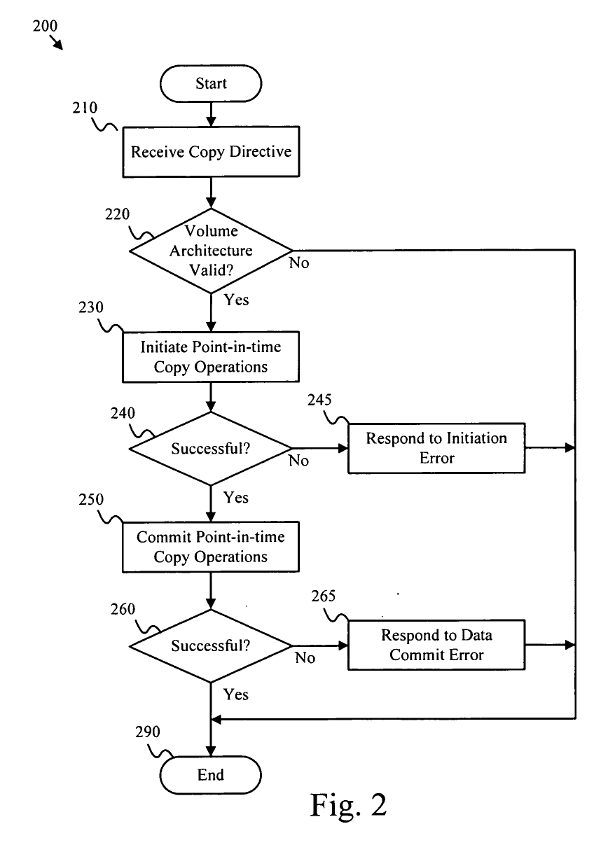

The local storage system 110 receives point-in-time copy directives, which may be directed to the local copy module 125. The local copy module 125 may retrieve data from the local source volume 120 and copy the data to the local copy volume 130. In some embodiments, the local copy module 125 mirrors the point-in-time copy directive to the remote copy module 160 via the communication link 145. In other embodiments, the point-in-time copy directive is mirrored by the local mirroring module 140 to the remote mirroring module 180. Additional detailed regarding proper mirroring of point-in-time copy directives and handling errors associated therewith will be described in conjunction with the schematic flow chart diagrams depicted in FIGS. 2-4

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the order in which a particular method occurs may or may not strictly adhere to the order of the corresponding steps shown. Furthermore, one of skill in the art will appreciate that references within this specification to specific units of storage such as volumes and datasets need not limit the scope of the present invention to the referenced units of storage. For example, the data replications operations referenced herein may be conducted on any logical or physical units of storage such as volumes, virtual volumes, datasets, files, blocks, sectors, tracks, and pages.

FIG. 2 is a schematic flow chart diagram illustrating one embodiment of a data replication method 200 in accordance with the present invention. The data replication method 200 includes a receive copy directive step 210, a validity test 220, an initiate step 230, a successfully initiated test 240, a handle initiation error step 245, a commit copy operations step 250, a successfully committed test 260, and a handle data commit error step 265.

The receive copy directive step 210 receives a point-in-time copy command to be performed in conjunction with the local storage system 110 and mirrored to the remote storage system 150. The point-in-time copy command specifies a dataset or other unit of storage that the local copy module 125 is to replicate from the local source volume 120 to the local copy volume 130. The point-in-time copy command is also to be mirrored to the remote storage system 150, directing a corresponding unit of storage to be copied from the remote source volume 160 to the remote copy volume 170.

The validity test 220 verifies that a suitable volume configuration is present in the copy replication system 100 to support replication of the point-in-time copy directive. In one embodiment, the validity test 220 verifies the existence of a mirroring relationship between the local source volume 120 and the remote source volume 160, and between the local copy volume 130 and the remote copy volume 170. The validity test 220 may also verify the existence of a point-in-time copy relationship between the local source volume 120 and the local copy volume 130, and between the remote source volume 160 and the remote copy volume 170. In some embodiments, point-in-time volume relationships may be created in the course of servicing a point-in-time copy directive, so a point-in-time copy directive may be received even though point-in-time volume relationships have not been established. If the suitable volume relationships may be established, the depicted point-in-time data replication method 200 continues with the initiate step 230, otherwise the data replication method ends 290.

The initiate step 230 establishes relationships between corresponding datasets or other units of storage specified by the received point-in-time copy directive. The initiate step 230 establishes relationships between the local source volume 120 and the local copy volume 130, and between the remote source volume 160 and the remote copy volume 170. In one embodiment, the relationships are established by replicating the point-in-time copy directive to the remote site via the communication link 145. The validity test 220 previously verified the existence of a mirroring relationship between the local source volume 120 and the remote source volume 160, and between the local copy volume 130 and the remote copy volume 170. Establishing relationships between the various datasets involved in replicating the point-in-time copy directive ensures that data is managed correctly and that data integrity is maintained in case of a replication failure in either the local storage system 110 or the remote storage system 150. In various embodiments, the relationship between corresponding datasets may be a lock on a disk track, a volume block, a file, or a record. In some embodiments, the relationship between corresponding datasets may be a revertible point-in-time copy directive.

In certain embodiments, the actual data replication operations that occur in response to a point-in-time copy command need not occur at the time the point-in-time copy command is received and may be conducted on a deferred basis. For example, data replication may proceed as a background process, or may be deferred until the data on the source volume is modified. In certain embodiments, read operations to a copy volume (such as the copy volumes 130 and 170) may be redirected to a source volume (such as the source volumes 120 and 160) until the data is actually replicated to the copy volume.

The successfully initiated test 240 determines whether the relationships between corresponding datasets were successfully established. In the depicted embodiment, the successfully initiated test 240 succeeds only if point-in-time relationships are established between both the local source volume 120 and the local copy volume 130, and the remote source volume 160 and the remote copy volume 170. If the successfully initiated test 240 fails, the depicted data replication method 200 continues with the handle initiation error step 245, otherwise the data replication method 200 continues with the commit step 250.

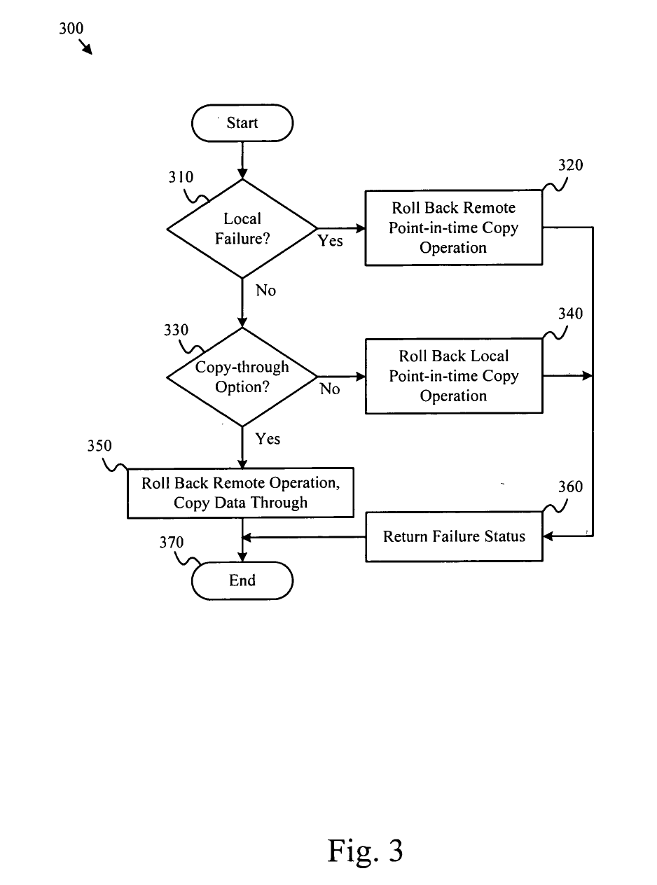

The respond to initiation error step 245 handles error reporting and recovery in the event of a failure to establish relationships between corresponding datasets in the initiate step 230. One embodiment of the respond to initiation error step 245 is illustrated in the initiation error handling method 300 depicted in FIG. 3. In another embodiment, the respond to initiation error step 245 withdraws relationships established by the initiate step 230 and returns a failure status to the calling process.

The commit copy operations step 250 commits the relationships between corresponding datasets or units of storage established by the initiate step 230. In certain embodiments, the commit copy operations step 250 is a two phase process that commits the copy operation on the local storage system 110 and subsequently (if there are no errors) on the remote storage system 150.

The successfully committed test 260 determines whether the copy operations were successfully committed in the commit step 250. If the successfully committed test 260 is negative, the data replication method 200 continues with the respond to data commit error step 265, otherwise the data replication method 200 ends 290.

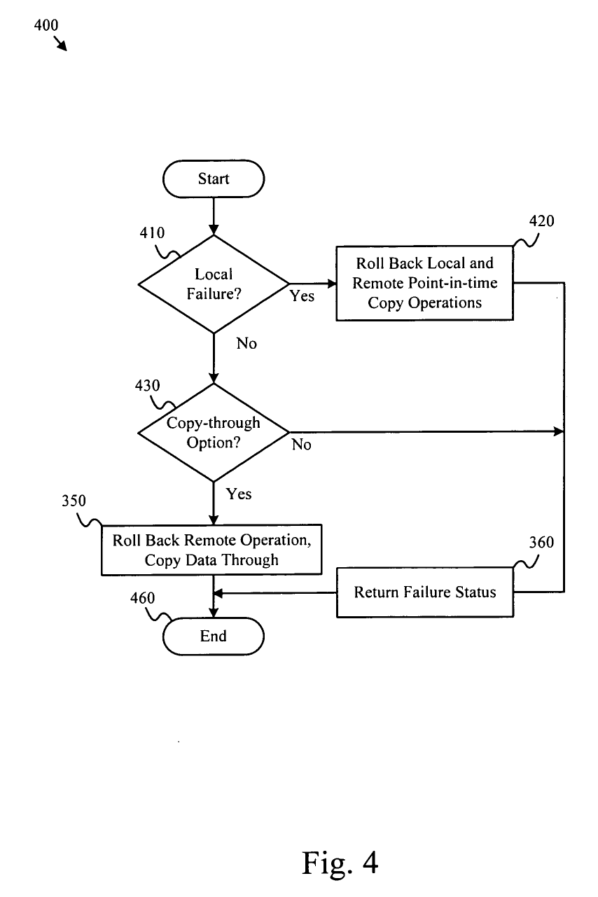

The respond to commit error step 265 handles error reporting and recovery in the event of a failure to commit a replication operation in the commit step 250. One embodiment of the respond to commit error step 265 is the commit error response method 400 illustrated in FIG. 4. In another embodiment, the respond to data commit error step 265 rolls back both the local and remote point-in-time copy operations if neither was successful and reports a failure status to the calling process. Upon completion of the handle commit error step 265, the data replication method 200 ends 290.

FIG. 3 is a schematic flow chart diagram illustrating one embodiment of an initiation error handling method 300 of the present invention. The initiation error handling method 300 includes a local copy failure test 310, a roll back remote copy step 320, a copy-through option test 330, a roll back local copy step 340, a copy data through step 350, and a return failure status step 360.

The local copy failure test 310 determines whether the point-in-time copy directive performed by the local storage system 110 failed to be completed. A point-in-time copy may fail for a number of reasons, including failure to establish the point-in-time copy relationship between the local source volume 120 and the local copy module 130, and failure to commit the copy relationship on the local copy volume 130. If the local point-in-time copy directive failed, the initiation error handling method 300 continues with the roll back remote copy step 320, otherwise it continues with the copy-through option test 330.

The roll back remote copy step 320 reverts the remote point-in-time copy directive in the event of a failure of a point-in-time copy in the local storage system 110. Unlike a failure of a remote point-in-time copy directive, if the local point-in-time copy fails, an alternate communication path does not exist to complete copying of the data. To maintain integrity of all copies of the datasets, the roll back remote copy step 320 rolls back the point-in-time copies on the remote storage system 150.

The copy-through option test 330 determines whether a configurable option has been selected to allow data to be mirrored from the local copy volume 130 to the remote copy volume 170 in the event of a failure to mirror a point-in-time copy directive to the remote storage system 150. One benefit provided by the present invention is access to identical data at both a local and remote site. Embodiments of the point-in-time copy replication system 100 may permit mirroring of data between the local copy volume 130 and the remote copy volume 170, via the communication link 145, in the event of failure to mirror the point-in-time copy to the remote storage system 150. If the copy replication system 100 is configured to allow data copy-through, the initiation error handling method 300 continues with the copy data through step 350, otherwise it continues with the roll back local copy step 340.

The roll back local copy step 340 reverts the local point-in-time copy directive in the event of a failure of a point-in-time copy in the remote storage system 150 if the copy replication system 100 was not directed to allow a copy-through operation. Conducting a copy-through operation or rolling back the point-in-time copy directive performed on the local storage system 110 maintains the integrity of all copies of the datasets.

The copy data through step 350 rolls back the remote point-in-time copy operation and copies data from the local copy volume 130 to the remote copy volume 170, via the local and remote mirroring modules 140 and 180, and the communication link 145. Mirroring data by this method may increase the availability latency for access to a point-in-time copy at the remote site compared to mirroring a point-in-time copy directive. However, mirroring the point-in-time copy maintains the integrity of the data between the local and remote sites even when mirroring a point-in-time copy directive fails.

The return failure status step 360 returns a failure status to the calling process in the event that a point-in-time copy directive could not be mirrored to the remote storage system 150 and the copy replication system 100 is not configured to allow data copy-through from the local copy volume 130 to the remote point-in-time copy volume 170. The calling process may elect to retry the point-in-time copy directive, or conduct recovery operations appropriate to the application.

FIG. 4 is a schematic flow chart diagram illustrating one embodiment of an operation commit error handling method 400 in accordance with the present invention. The data commit error handling method 400 includes components of the initiation error handling method 300 depicted in FIG. 3. In addition, the data commit error handling method includes a local failure test 410, a roll back copies step 420, and a copy-through option test 430.

The local copy failure test 410 determines whether the point-in-time copy directive performed by the local storage system 110 failed to be committed. If the local point-in-time copy directive failed, the commit error handling method 400 continues with the roll back copies step 420, otherwise it continues with the copy-through option test 430.

The roll back copies step 420 reverts the local and remote point-in-time copy directives in the event of a failure of a point-in-time copy commit in the local storage system 110. If the local point-in-time copy directive is unable to commit, rolling back both the local and remote point-in-time copy directives maintains integrity of all copies of the datasets.

The copy-through option test 430 determines whether the replication system 100 has been directed, by an application or the like, to conduct a copy-through operation from the local copy volume 130 to the remote copy volume 170 in the event of a failure to mirror a point-in-time copy commit directive to the remote storage system 150. Certain embodiments of the point-in-time copy replication system 100 may permit mirroring of data between the local copy volume 130 and the remote copy volume 170, via the communication link 145, in the event of failure to mirror the point-in-time copy to the remote storage system 150. If the replication system 100 has not been directed to conduct a copy-through operation the method returns 360 a failure status and ends 460.

If the copy replication system 100 has been directed to conduct a copy-through, the commit error handling method 400 continues by rolling back the remote point-in-time copy operation and copying the appropriate data from the local copy volume 130 to the remote copy volume 170. Subsequently, the method ends 460.

the present invention provides timely access to identical point-in-time copies of data at both a local and a remote site. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for local and remote replication of data, the apparatus: comprising:
a mirroring module configured to mirror local data to a remote data store in order to provide a remote copy of the local data;
a copy module configured to conduct a local point-in-time copy operation to provide a local point-in-time copy of the local data;
the copy module further configured to initiate a remote point-in-time copy operation on the remote data store [via a communication link in order to provide a remote point-in-time copy of the local data]; and
the copy module further configured to initiate reversion of the local point-in-time copy operation in response to failure of the remote point-in-time copy operation.

2. The apparatus of claim 1, wherein the copy module is further configured to enter a commit state with regard to the local point-in-time copy operation in response to successful execution of the local and remote point-in-time copy operations.

3. The apparatus of claim 1, wherein the copy module is further configured to initiate the remote point-in-time copy operation on the remote data store in response to receiving a point-in-time copy directive.

4. The apparatus of claim 1, wherein the copy module is further configured to initiate the remote point-in-time copy operation on the remote data store by mirroring the point-in-time copy directive over a communication link.

5. An apparatus for local and remote replication of data, the apparatus comprising:
a mirroring module configured to receive data from a remote data store in order to provide a local copy of remote data;
a copy module configured to receive a mirrored point-in-time copy directive from the remote data store and conduct a local point-in-time copy operation on the local copy of the remote data to provide a local point-in-time copy of the remote data; and
the copy module further configured to initiate reversion of the local point-in-time copy operation in response to failure of a remote point-in-time copy operation.

6. The apparatus of claim 5, wherein the copy module is further configured to enter a commit state with regard to the local point-in-time copy operation in response to successful execution of the local and remote point-in-time copy operations.

7. A system for local and remote replication of data, the system comprising:
a local data store configured to conduct a local point-in-time copy operation on local data;
the local data store further configured to mirror local data to a remote data store in order to provide a remote copy of the local data;
a remote data store configured to conduct a remote point-in-time copy operation on remote data;
the local data store further configured to mirror point-in-time copy directives on the local data store to the remote data store and thereby initiate a remote point-in-time copy operation on the remote copy of the local data; and
the local data store further configured to roll back the local point-in-time copy operation in response to a failure in the remote point-in-time copy operation.

8. The system of claim 7, wherein the remote data store is further configured to revert the remote point-in-time copy operation in response to a failure in the local point-in-time copy operation.

9. The system of claim 7, wherein the local and remote data stores are further configured to enter a commit state with regard to the local and remote point-in-time copy operations in response to successful execution of the local and remote point-in-time copy operations.

10. A signal bearing medium tangibly embodying a program of machine-readable instructions executable by a digital processing apparatus to perform an operation for local and remote replication of data, the operation comprising:
mirroring local data to a remote data store in order to provide a remote copy of the local data;
conducting a local point-in-time copy operation to provide a local point-in-time copy of the local data;
initiating a remote point-in-time copy operation on the remote data store to provide a remote point-in-time copy of the local data; and
initiating reversion of the local point-in-time copy operation in response to failure of the remote point-in-time copy operation.

11. The signal bearing medium of claim 10, further comprising entering a state committing the local point-in-time copy operation in response to successful execution of the local and remote point-in-time copy operations.

12. The signal bearing medium of claim 10, further comprising committing the remote point-in-time copy operation in response to successful execution of the local and remote point-in-time copy operations.

13. The signal bearing medium of claim 10, wherein conducting the local point-in-time copy operation occurs in response to receiving a point-in-time copy directive.

14. The signal bearing medium of claim 10, wherein initiating the remote point-in-time copy operation on the remote data store occurs in response to receiving a point-in-time copy directive.

15. The signal bearing medium of claim 10, the operation further comprising committing the point-in-time copy directives in response to a determination of an absence of errors.

16. The signal bearing medium of claim 15, further comprising responding to a point in time copy failure by:
rolling back any point-in-time data copy procedures successfully completed;
rolling back local and remote point-in-time data copy procedures upon failure of the local copy commit; and
performing a failure recovery procedure upon failure of the remote copy commit according to configurable parameters, the failure recovery procedure selected from returning a copy failure status to the calling procedure, and allowing data copying to be completed by a data mirroring system.

17. A method for local and remote replication of data, the method comprising:
initiating local point-in-time data copy procedures;
mirroring local data to a remote data store in order to provide a remote copy of the local data; and
mirroring local point-in-time data copy directives to a remote data store.

18. The method of claim 17, the method further comprising making a decision to commit or roll back point-in-time copy directives.

19. The method of claim 17, further comprising responding to a point-in-time data copy failure.

20. The method of claim 17, wherein responding to a point-in-time data copy failure comprises:
rolling back any point-in-time data copy procedures successfully completed;
rolling back local and remote point-in-time data copy procedures upon failure of the local copy commit; and
performing a failure recovery procedure upon failure of the remote copy commit according to configurable parameters, the failure recovery procedure selected from returning a copy failure status to the calling procedure, and allowing data copying to be completed by a data mirroring system.

21. An apparatus for local and remote replication of data, the apparatus comprising:
means for initiating local point-in-time data copy procedures;
means for mirroring local data to a remote data store and thereby providing a remote copy of the local data; and
means for mirroring local point-in-time data copy directives to a remote data store.

22. The apparatus of claim 21, the apparatus further comprising means for entering a state committing local and remote point-in-time data copies.

23. The apparatus of claim 21, further comprising means for responding to point-in-time data copy failure.

24. The apparatus of claim 22, wherein the means for responding to point-in-time data copy failure further comprises:
means for rolling back any point-in-time data copy procedures successfully completed;
means for rolling back local and remote point-in-time data copy procedures upon failure of the local copy commit; and
means for performing a failure recovery procedure upon failure of the remote copy commit according to configurable parameters, the failure recovery procedure selected from returning a copy failure status to the calling procedure, and allowing data copying to be completed by a data mirroring system.
